(19) United States
(12) Patent Application Publication
(10) Pub. No.: US 2019/0379942 A1
(43) Pub. Date: Dec. 12, 2019

(54) METHOD AND APPARATUS FOR PROCESSING MULTIMEDIA RESOURCES

(71) Applicant: YOUKU INTERNET TECHNOLOGY (BEIJING) CO., LTD., Dongcheng District, Beijing (CN)

(72) Inventors: Diyang HAN, Hangzhou (CN); Yi FANG, Hangzhou (CN); Fei HONG, Hangzhou (CN); Aobo ZHANG, Hangzhou (CN)

(21) Appl. No.: 16/482,858

(22) PCT Filed: Nov. 24, 2017
(86) PCT No.: PCT/CN2017/112792

§ 371 Date: Aug. 1, 2019

(30) Foreign Application Priority Data
Mar. 2, 2017 (CN) 201710120684.2

(51) Int. Cl. H04N 21/472; H04N 21/442; H04N 21/845

(52) U.S. Cl. CPC H04N 21/47202; H04N 21/44213; H04N 21/47214; H04N 21/8456; H04N 21/44204; H04N 21/47217

(57) ABSTRACT

The disclosure relates to methods and apparatuses for processing multimedia resources. In one embodiment, a method comprises: obtaining a time distribution of one or more icons entered by one or more users with respect to multimedia resources; determining a specific period of the multimedia resources based on the time distribution; and in response to a request for the specific period from a user, executing an operation corresponding to the request on the multimedia resources corresponding to the specific period. Since icons can reflect viewing reactions of the user, the specific period obtained by the disclosed embodiments can be used to effectively segment multimedia resources based on a user reaction, facilitating rapid obtaining of a segment of interest by the user and improving the viewing experience of the user and efficiency of the device processing the multimedia resources.

### CROSS REFERENCE TO RELATED APPLICATIONS

This application is the National Stage of, and claims priority to, Int'l Appl. No. PCT/CN2017/112792 filed Nov. 24, 2017 which claims priority to Chinese Application No. 201710120684.2 filed Mar. 2, 2017, both of which are incorporated herein by reference in their entirety.

### BACKGROUND

### Technical Field

The disclosure relates to the field of multimedia technology, and in particular to methods and apparatuses for processing multimedia resources.

### Description of the Related Art

Users have increasingly high expectations regarding their multimedia resource viewing experience. For example, a user watching a video may want to be able to watch certain segments of interest in the video in a targeted manner in addition to watching the entire video. As a result, there exists a need in the art to quickly and effectively segment multimedia resources and find segments that a user may be interested in so the user can watch them in a targeted manner. Current solutions fail to remedy this technical deficiency, as described further herein.

### SUMMARY

The disclosure proposes methods and apparatuses for processing multimedia resources.

According to one embodiment, a method for processing multimedia resources is provided comprising: obtaining a time distribution of one or more icons entered by one or more users with respect to multimedia resources; determining a specific period of the multimedia resources based on the time distribution; and in response to a request for the specific period from a user, executing an operation corresponding to the request on the multimedia resources corresponding to the specific period.

According to another embodiment, an apparatus for processing multimedia resources is provided, the apparatus comprising: an obtaining module for obtaining a time distribution of one or more icons entered by one or more users with respect to multimedia resources; a determining module for determining a specific period of the multimedia resources based on the time distribution; and an execution module for, in response to a request for the specific period from a user, executing an operation corresponding to the request on the multimedia resources corresponding to the specific period.

According to another embodiment, an apparatus for processing multimedia resources is provided comprising: a processor; and a memory for storing instructions executable by the processor, wherein the processor is configured to execute the above-described method. According to another embodiment, a non-volatile computer-readable storage medium is provided, wherein instructions in the storage medium, when executed by a processor of a terminal and/or a server, causes the terminal and/or the server to execute the above-described method.

Through determining a specific period of multimedia resources based on a time distribution of an icon entered by a user with respect to the multimedia resources and through executing an operation on the multimedia resources of the specific period, the disclosed embodiments for processing multimedia resources can effectively execute segment multimedia resources for a user to view segments and execute operations in a targeted manner. Since icons can well reflect various reactions (e.g., emotions) of a user in viewing multimedia resources, the specific period obtained using the disclosed embodiments can be used to effectively and efficiently segment multimedia resources based on a user reaction, facilitating rapid obtaining of a segment of interest for the user and improving the viewing experience of the user.

Other features and aspects of the disclosure will become apparent through the following detailed description of exemplary embodiments with reference to the accompanying drawings.

### BRIEF DESCRIPTION OF THE DRAWINGS

The accompanying drawings, which are included in the specification and form part of the specification, illustrate exemplary embodiments, features, and aspects of the disclosure together with the specification, and are used to explain the principles of the disclosure.

FIG. 1 is a flow chart illustrating a method for processing multimedia resources according to some embodiments of disclosure.

FIG. 2 is a flow chart illustrating a method for processing multimedia resources according to some embodiments of disclosure.

FIG. 3 is a flow chart illustrating a method for processing multimedia resources according to some embodiments of disclosure.

FIG. 4 is a flow chart illustrating a method for processing multimedia resources according to some embodiments of disclosure.

FIG. 5 is a flow chart illustrating a method for processing multimedia resources according to some embodiments of disclosure.

FIG. 6 is a flow chart illustrating a method for processing multimedia resources according to some embodiments of disclosure.

FIG. 7 is a flow chart illustrating a method for processing multimedia resources according to some embodiments of disclosure.

FIG. 8 is a flow chart illustrating a method for processing multimedia resources according to some embodiments of disclosure.

FIG. 9 is a flow chart illustrating a method for processing multimedia resources according to some embodiments of disclosure.

FIG. 10 is a block diagram illustrating an apparatus for processing multimedia resources according to some embodiments of disclosure.

FIG. 11 is a block diagram illustrating an apparatus for processing multimedia resources according to some embodiments of disclosure.

FIG. 12 is a block diagram illustrating an apparatus for processing multimedia resources according to some embodiments of disclosure.

FIG. 13 is a block diagram illustrating an apparatus for processing multimedia resources according to some embodiments of disclosure.

FIG. 14 is a block diagram illustrating an apparatus for processing multimedia resources according to some embodiments of disclosure.

FIG. 15 is a block diagram illustrating an apparatus for processing multimedia resources according to some embodiments of the disclosure.

### DETAILED DESCRIPTION

Various exemplary embodiments, features, and aspects of the disclosure will be described in detail below with reference to the accompanying drawings. The same reference numerals in the drawings represent elements having the same or similar functions. While various aspects of the embodiments are illustrated in the drawing, the drawings are not necessarily drawn to scale unless specifically stated. The word “exemplary” dedicated herein means “used as an example or an embodiment, or is illustrative.” Any of the embodiments illustrated herein as “exemplary” is not necessarily interpreted as being superior to or better than other embodiments. In addition, to better illustrate the disclosure, numerous specific details are given in the detailed description below. It should be understood by those skilled in the art that the disclosure can be implemented without some of the specific details. In some examples, the methods, means, elements, and circuits well known to those skilled in the art are not described in detail to highlight the gist of the disclosure.

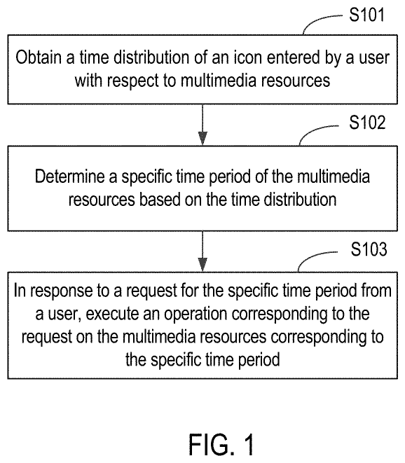

FIG. 1 is a flow chart illustrating a method for processing multimedia resources according to some embodiments of disclosure. The method can be implemented by one or more servers or terminal devices such as smartphones and computers. As shown in FIG. 1, the method can comprise the following steps.

Step S101: obtain a time distribution of an icon entered by a user with respect to multimedia resources;

Step S102: determine a specific period of the multimedia resources based on the time distribution; and

Step S103: in response to a request for the specific period from a user, execute an operation corresponding to the request on the multimedia resources corresponding to the specific period.

Through determining a specific period of multimedia resources based on a time distribution of an icon entered by a user with respect to the multimedia resources and through executing an operation on the multimedia resources of the specific period, the method for processing multimedia resources according to various aspects of the disclosure can effectively execute segment division on multimedia resources for a user to view segments and execute operations in a targeted manner. Since the icons reflect the viewing reaction of the users, the specific period obtained by means of the method for processing multimedia resources according to various aspects of the disclosure can be used to effectively segment multimedia resources based on a user reaction, facilitating rapid obtaining of a segment of interest by the user and improving the viewing experience of the user.

The word “icon” herein may be any icon entered by a user with respect to multimedia resources, such as a smiley face, a weeping face, a shocked face, a heart icon, a user-defined icon, and the like. The icon can be either one preset in a system or one configured (e.g., added, saved and the like) by users themselves. A user can enter an icon through any means, such as by clicking or entering a shortcut. The icon can be an icon entered by the user either in real time or non-real time during watching multimedia resources. For example, the icon may be an icon in a bullet screen (or other mechanism allowing for social commenting on multimedia files) entered by the user with respect to multimedia resources.

The user in step S101 can be either a certain user or a plurality of users within a certain statistical range. For example, a time distribution of an icon entered by a certain user can be statistically analyzed or time distributions of icons entered by all users having interacted with a server with respect to a certain video within a certain period (e.g., a month) can be statistically analyzed. When statistical analysis is executed for one user, the method according to the embodiment can be executed by a terminal device or a server and when statistical analysis is executed for a plurality of users, the method according to the embodiment can be executed by a server.

In one embodiment, the icon can be an emoji. For example, a bullet screen entered by a certain user when watching a video may comprise an emoji expressing the user's emotion, for example, a smiley face, a weeping face, a shocked face, and the like. The server can obtain the type of the emoji and the entry time of each emoji. The time can be expressed as a time offset in the video timeline. For example, the server can obtain the following information: a certain user enters a smiley face icon when the video proceeds to 00:10:20. Similar statistical analysis can be executed for a plurality of users within a statistical range. Finally, the time distribution of the emoji, i.e., a correspondence between the emoji and the entering time thereof is obtained.

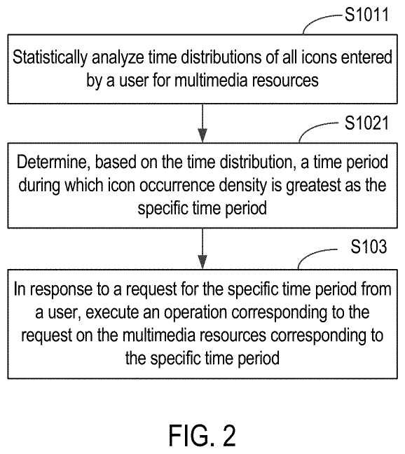

FIG. 2 is a flow chart illustrating a method for processing multimedia resources according to some embodiments of disclosure.

As shown in FIG. 2, in one embodiment, the obtaining a time distribution of an icon entered by a user with respect to the multimedia resources in step S101 can comprise the step (S1011) of statistically analyzing time distributions of all icons entered by the user with respect to the multimedia resources. The determining a specific period of the multimedia resources based on the time distribution in step S102 can comprise the step (1021) of determining, based on the time distribution, a period during which icon occurrence density is greatest as the specific period.

In the following example, the method for processing multimedia resources according to the disclosure will be explained using emojis as an example. Emojis mainly reflect a user's emotional reaction when watching multimedia resources, such as sadness, anger, and the like. However, the method for processing multimedia resources according to the disclosure is not limited to emojis. Other icons can also reflect a user's reaction in other aspects. For example, a user may send a lot of heart icons expressing one's fondness when the user watches a segment where a leading actor shows caring for or expressing feelings toward a leading actor. Therefore, examples of emojis should not be construed as limiting the protection scope of the disclosure.

Taking all users within a statistical range as an example, time distributions of all emojis entered by all users within a period (e.g., a month) can be statistically analyzed. In one embodiment, a timeline of a video can be segmented into a plurality of unit periods by unit time (e.g., 1 minute); and the number of times each type of emoji is entered per unit period is statistically analyzed, as shown in Table 1.

TABLE 1

| | | | | | Total |
|---|---|---|---|---|---|
| | | | Weep- | | number |
| | Grinning | Smiling | ing | Despising | of |
| Period | face | face | face | face | times |
| 00:00:00-00:01:00 | 60 | 0 | 0 | 2 | 62 |
| 00:00:00-00:02:00 | 9 | 1 | 0 | 0 | 10 |

. . .

| | | | | | |
|---|---|---|---|---|---|
| 00:50:00-00:51:00 | 100 | 0 | 0 | 0 | 100 |

. . .

| | | | | | |
|---|---|---|---|---|---|
| 00:60:00-00:61:00 | 0 | 0 | 99 | 0 | 99 |
| Number of times | 169 | 1 | 99 | 2 | N/A |

The “icon occurrence density” in step S1021 can be the total number of icon occurrences per unit time. For example, during the period 00:50:00-00:51:00, the total number of emoji occurrences is 100. Assuming 100 is a greatest value among all periods, then 00:50:00-00:51:00 can be determined as a specific period.

The specific period determined in this way can be considered a period during which emotional expression of the user is most intense in a viewing process and multimedia resource content in this period can be identified as relatively exciting and intense. The multimedia resources of the period can be associated with a specific operation control, such as a “click to display high-energy segments” button in a multimedia resource playing interface. When the user clicks the button, a corresponding request can be generated. In response to the request, the server can skip to the above specific period 00:50:00-00:51:00 for playback so that the user can conveniently watch exciting segments in the multimedia resources.

In another embodiment, the determining a specific period of the multimedia resources based on the time distribution can comprise: determining, based on the time distribution, a plurality of periods during which icon occurrence density is greatest as the specific period. For example, the number of occurrences of an emoji in each period can be ranked. A plurality of (for example, two) periods with the top-ranked largest numbers of occurrences is obtained. During the two periods in Table 1, namely 00:50:00-00:51:00 and 00:60:00-00:61:00, emojis were entered 100 and 99 times respectively. These are the two periods having the largest numbers of occurrences. The above two periods are sequentially associated with a “click to display high-energy segments” button in a multimedia resource playing interface. When the user clicks the button, a corresponding request can be generated. In response to the request, the server can skip to the above specific period 00:50:00-00:51:00 for playback; and after the playing is completed, the server skips to the period 00:60:00-00:61:00 for playback.

Alternatively, after the specific period of the multimedia resources is determined, multimedia resources corresponding to the specific period can be merged. For example, multimedia resource segments obtained by merging multimedia resource segments of the above two periods are stored in the server and then associated with the “click to display high-energy segments” button. When the user clicks the button, a corresponding request can be generated. In response to the request, the server can play the merged multimedia resource segments. With the method for processing multimedia resources according to the above embodiment of the disclosure, a user can conveniently watch exciting segments in multimedia resources.

Although an implementation of determining a plurality of periods as a specific period is introduced above by taking two periods as an example, those skilled in the art should understand that the disclosure is not limited thereto. In fact, a user can configure the number of specific periods depending on personal preferences and/or actual application scenarios.

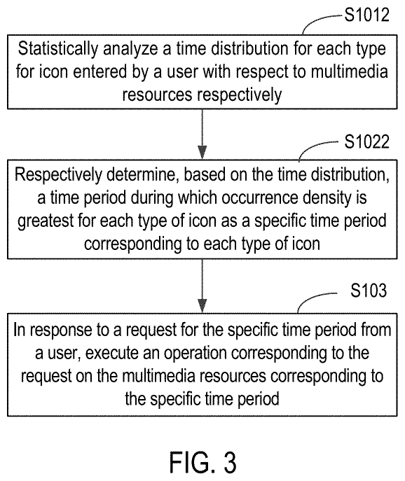

FIG. 3 is a flow chart illustrating a method for processing multimedia resources according to some embodiments of disclosure.

As shown in FIG. 3, in one embodiment, the obtaining a time distribution of an icon entered by a user with respect to multimedia resources in step S101 can comprise the step (S1012) of statistically analyzing a time distribution for each type of icon entered by the user with respect to the multimedia resources respectively. The determining a specific period of the multimedia resources based on the time distribution in step S102 can comprise the step (1022) of respectively determining, based on the time distribution, a period during which occurrence density is greatest for each type of icon as a specific period corresponding to each type of icon.

In this way, the icon can be statistically analyzed in terms of type. The disclosure is exemplified still by referring to the example given in Table 1. What can be determined is that a period during which occurrence density of a grinning face icon is greatest (i.e., a specific period corresponding to the grinning face icon) is 00:50:00-00:51:00; and a period during which occurrence density of a weeping face icon is greatest (i.e., a specific period corresponding to the weeping face icon) is 00:60:00-00:61:00.

It is noted that the icons types can comprise one or a plurality of icon types. For example, smiling face icons and grinning face icons can be classified as smiley face icons. The classified smiley face icons can be statistically analyzed. For example, during a period 00:00:00-00:02:00, the total number of occurrences of the smiley face icons (grinning face icons+smiling face icons) is 10.

The specific period determined in this way can be identified as a period during which expression of each type of emotion of a user is most intense in a viewing process. For example, a specific period corresponding to smiley face icons can be identified as the happiest period; and a specific period corresponding to weeping face icons can be identified as the saddest period. Multimedia resources of each specific period can be associated with a specific operation control. For example, a specific period corresponding to a smiley face icon can be associated with a “click to display happy segments” button in a multimedia resource playing interface. When the user clicks the button, a corresponding request can be generated. In response to the request, the server can skip to the above specific period 00:50:00-00:51:00 for playback. A specific period corresponding to a weeping face icon can be associated with a “click to display sad segments” button in the multimedia resource playing interface. When the user clicks the button, a corresponding request can be generated. In response to the request, the server can skip to the above specific period 00:60:00-00:61:00 for playback. In this way, the user can conveniently watch different types of exciting segments in multimedia resources.

In another implementation, a plurality of periods during which occurrence density is greatest for each type of icon can be determined based on the time distribution as a specific period corresponding to each type of icon. For example, as shown in Table 1, two periods during which occurrence density of a grinning face icon is greatest can be determined as 00:50:00-00:51:00 (100 times) and 00:00:00-00:01:00 (60 times); and the two periods can be used as specific periods corresponding to a grinning face icon. The two periods are associated with a “click to display happy segments” button in a multimedia resource playing interface; or multimedia resources obtained by merging of the two periods are associated with the “click to display happy segments” in the multimedia resource playing interface. When a user clicks the button, a corresponding request can be generated. In response to the request, the server can skip to the above specific periods 00:00:00-00:01:00 and 00:50:00-00:51:00 for playback.

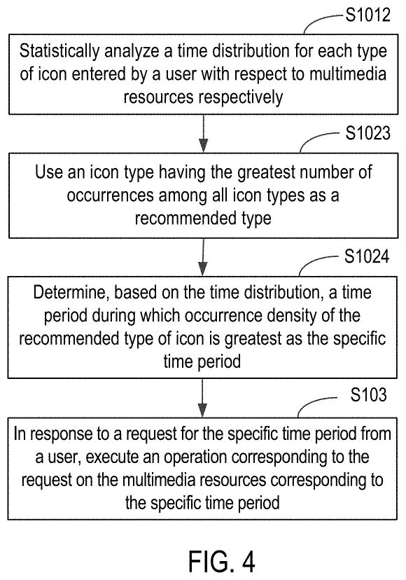

FIG. 4 is a flow chart illustrating a method for processing multimedia resources according to some embodiments of disclosure.

As shown in FIG. 4, in one embodiment, the obtaining a time distribution of an icon entered by a user with respect to multimedia resources in step S101 can comprise the step (S1012) of statistically analyzing a time distribution for each type of icon entered by the user with respect to the multimedia resources respectively.

The determining a specific period of the multimedia resources based on the time distribution in step S102 can comprise:

Step S1023: using an icon type having the greatest number of occurrences among all icon types as a recommended type; and

Step S1024: determining, based on the time distribution, a period during which occurrence density of the recommended type of icon is greatest as the specific period.

Using this process, it can be determined which type of icon is sent most frequently by a user during viewing a multimedia video. A specific period determined based on the icon can be considered to reflect a most representative viewing reaction of a user with respect to the multimedia resources, and can reflect features of the multimedia resources of the specific period. The specific period determined based on the icon can be one period or one period resulting from merging a plurality of periods, which is not limited in the disclosure.

Still taking Table 1 as an example, an icon of which the number of occurrences is greatest among all emoji types is the grinning face icon, which occurred 169 times. Alternatively, the grinning face icon and the smiling face icon can be combined into one type, i.e., smiley face icons; and then the smiley face icon is statistically analyzed. The number of occurrences of the smiley face icons is 170. The grinning face icon can be used as a recommended type; and the period 00:50:00-00:51:00 during which occurrence density of the grinning face icon is greatest is used as the specific period. Alternatively, the periods 00:00:00-00:01:00 and 00:50:00-00:51:00 during which occurrence density of the grinning face icon is greatest are used as the specific periods.

The multimedia resources of the period can be associated with a specific operation control, for example, the “click to display high-energy segments” button in the multimedia resource playing interface. When the user clicks the button, a corresponding request can be generated. In response to the request, the server can skip to the above specific period 00:50:00-00:51:00 (or 00:00:00-00:01:00 and 00:50:00-00:51:00) for playback, so that the user can conveniently watch exciting segments in the multimedia resources that can best represent emotional features of the multimedia resources.

In step S103, in response to a request for the specific period from a user, an operation corresponding to the request, for example, a skip playback operation as described above and the like, can be executed on the multimedia resources corresponding to the specific period.

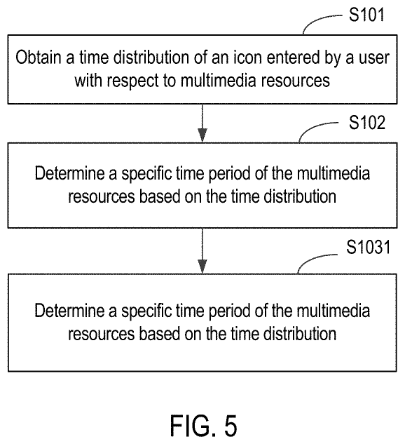

FIG. 5 is a flow chart illustrating a method for processing multimedia resources according to some embodiments of disclosure.

As shown in FIG. 5, in one embodiment, in response to a request for the specific period from a user, executing an operation corresponding to the request on the multimedia resources corresponding to the specific period in step S103 can comprise the step (S1031) of skipping to and playing the multimedia resources corresponding to the specific period in response to a request for selecting playback of the specific period from the user.

The above process is illustrated by taking the embodiment shown in FIG. 2 and Table 1 as an example. After the specific period (00:50:00-00:51:00) is determined, the server can associate the multimedia resources of the period with a specific operation control, for example, the “click to display high-energy segments” button in the multimedia resource playing interface. When the user clicks the button, a corresponding request (i.e., the request for selecting playback of the specific period from the user) can be generated. In response to the request, the server can skip to the specific period 00:50:00-00:51:00 for playback, so that the user can conveniently watch exciting segments in the multimedia resources. Regarding the example in which a plurality of periods are determined as the specific periods, the periods can be associated with the “click to display high-energy segments” in the multimedia resource playing interface in the same way as that described above, which is not repeatedly described.

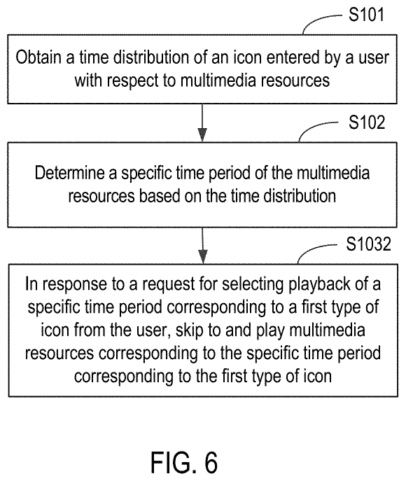

FIG. 6 is a flow chart illustrating a method for processing multimedia resources according to some embodiments of disclosure.

As shown in FIG. 6, in one embodiment, the in response to a request for the specific period from a user, executing an operation corresponding to the request on the multimedia resources corresponding to the specific period in step S103 can comprise the step (S1032) of skipping to and playing multimedia resources corresponding to the specific period corresponding to the first type of icon in response to a request for selecting playback of a specific period corresponding to a first type of icon from the user.

The above process is illustrated by taking the embodiment shown in FIG. 3 and Table 1 as an example. After a specific period corresponding to each type of emoji is determined, for example, the specific period corresponding to the grinning face icon is 00:50:00-00:51:00 and the specific period corresponding to the weeping face icon is 00:60:00-00:61:00, the server can associate multimedia resources of each specific period with a specific operation control. For example, the specific period corresponding to the smiley face icon is associated with the “click to display happy segments” button in the multimedia resource playing interface; and the specific period corresponding to the weeping face icon is associated with the “click to display sad segments” button in the multimedia resource playing interface. The user can click a corresponding button depending on user preferences/requirements. A client can generate a corresponding request. In response to the request, the server can skip to corresponding segments for displaying, so that the user can conveniently watch exciting segments of different emotion types in the multimedia resources.

In one embodiment, the request can be generated by clicking a skip playback control associated with the specific period, to facilitate operating by the user. As described above, after the specific period is determined, the specific period can be associated with a corresponding button. The client can generate a corresponding request according to an operation of the user clicking the button, and send the request to the server. The server executes skipping and playing in response to the request.

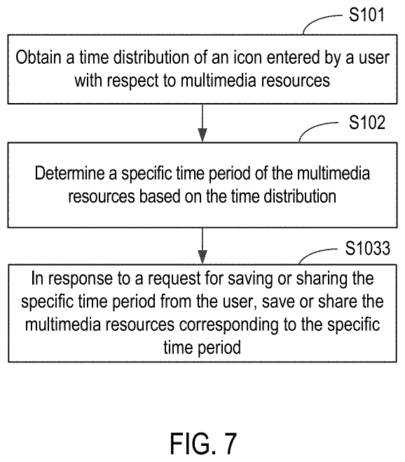

FIG. 7 is a flow chart illustrating a method for processing multimedia resources according to some embodiments of disclosure.

As shown in FIG. 7, in one embodiment, the in response to a request for the specific period from a user, executing an operation corresponding to the request on the multimedia resources corresponding to the specific period in step S103 can comprise the step (S1033) of saving or sharing the multimedia resources corresponding to the specific period in response to a request for saving or sharing the specific period from the user.

In one embodiment, the request for saving or sharing the specific period from the user can be generated by clicking a “save” or “share” control associated with the specific period. For example, after the specific period is determined, the specific period can be associated with the “save” or “share” control in the multimedia resource playing interface. When the user clicks the “save” control, the client will generate a corresponding request. In response to the request, the server can obtain multimedia resources corresponding to the specific period for downloading and locally saving by the client. Alternatively, when the user clicks the “share” control, the client will generate a corresponding request. In response to the request, the server can push an interface of a sharing configuration to the user, for example, a platform available for the user to select for sharing (other users, Moments, Weibo, homepages, and the like), a sharing manner (e.g., copying the link, forwarding and the like) and the like. A corresponding sharing manner is provided according to a user's selection. For example, if the user selects to execute sharing in a copying-the-link manner, then the server will provide a network link address corresponding to multimedia resources of a specific period to the user. The client can copy the network link address according to a user operation. Then the user can select to paste and send the copied link for sharing. The above sharing process is merely an example. It is known to those skilled in the art that other sharing manners can all be achieved through relevant prior art, which is not limited in the disclosure.

By means of saving and sharing, the method for processing multimedia resources according to the above embodiment of the disclosure can improve interaction between different users and a click rate of multimedia resources.

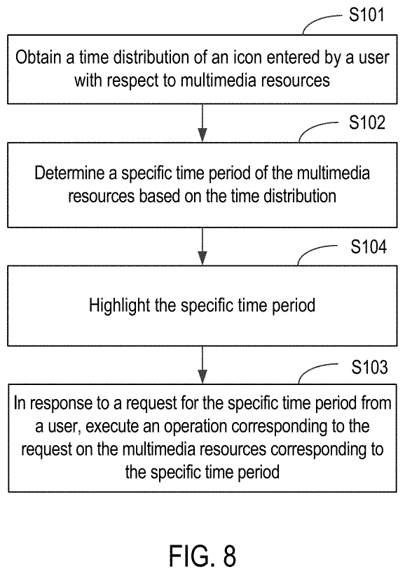

FIG. 8 is a flow chart illustrating a method for processing multimedia resources according to some embodiments of disclosure. As shown in FIG. 8, in one embodiment, the method can further comprise the step S104 of highlighting the specific period.

By taking a video as an example, the highlighting can be executed by highlighting, bold-displaying, or adding a mark to a progress bar portion corresponding to a specific period. If a plurality of specific periods are determined according to time distributions of all emojis, then all the specific periods can be highlighted. If one or a plurality of specific periods corresponding to each type of emoji are respectively determined according to a time distribution of each type of emoji, then corresponding specific periods are highlighted respectively in different manners (e.g., progress bar color, different markers, and the like) for different emoji types. Still taking a video as an example, if the progress bar is normally gray, then for one or a plurality of specific periods corresponding to the grinning face icon, the progress bar portion of the timeline can be highlighted in red; and for one or a plurality of specific periods corresponding to the weeping face icon, the progress bar portion of the timeline can be highlighted in blue. The foregoing is merely used as an example for illustration, and should not be construed as limiting the scope of the disclosure.

Highlighting the specific period can help the user to directly select and click the corresponding progress bar to execute operations such as playing, sharing, saving, or deletion.

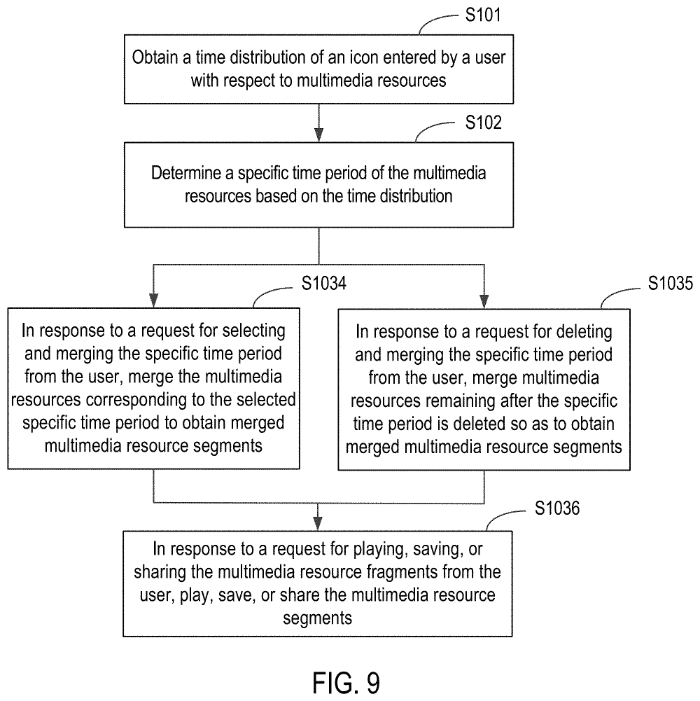

FIG. 9 is a flow chart illustrating a method for processing multimedia resources according to some embodiments of disclosure. As shown in FIG. 9, in one embodiment, the in response to a request for the specific period from a user, executing an operation corresponding to the request on the multimedia resources corresponding to the specific period in step S103 can comprise the following steps.

Step S1034: in response to a request for selecting and merging the specific period from the user, merging the multimedia resources corresponding to the selected specific period to obtain merged multimedia resource segments.

As shown in Table 1, a plurality of periods during which occurrence density of an emoji is greatest can be determined based on the time distribution and are used as the specific periods. For example, the number of occurrences of the emoji in each period can be ranked. If a plurality of periods with the top-ranked largest number of occurrences, for example, two periods are taken, then two periods 00:50:00-00:51:00 and 00:60:00-00:61:00 during which the emoji respectively occurs for 100 and 99 times are the two periods with the largest numbers of occurrences. The above two periods are associated with a “merge” button in the multimedia resource playing interface. When a user clicks the button, a corresponding request can be generated. In response to the request, the server can merge multimedia resources corresponding to the above two periods to obtain merged multimedia resource segments. In addition, all the specific periods can also be associated with the “merge” button in the multimedia resource playing interface. When a user clicks the button, a corresponding request can be generated. In response to the request, the server can generate a selection interface for the user to select periods required to be merged. The user can select in the selection interface periods that the user wants to merge. The server merges, according to the selection of the user, multimedia resources of corresponding periods to obtain merged multimedia resource segments. Alternatively, the specific period can be highlighted. The user selects all periods required to be merged or sequentially clicks periods required to be merged. The server will merge, according to a request from the user, multimedia resources of corresponding periods to obtain merged multimedia resource segments. With the method for processing multimedia resources according to the above embodiment of the disclosure, a user can conveniently select and watch exciting segments in multimedia resources. It should be noted that those skilled in the art could determine that merging of a plurality of multimedia resource segments can be achieved by using the existing relevant multimedia processing technology.

Step S103 can further comprise the step (S1036) of saving, or sharing the multimedia resource segments from the user, playing, saving, or sharing the multimedia resource segments in response to a request for playback.

For example, the above merged multimedia resource segments can be associated with a “play” button, a “save” button, and a “share” button in the multimedia resource playing interface. When a user clicks a corresponding button, a corresponding request can be generated. In response to the request, the server can play, save, or share the merged multimedia resource segments. Herein, the specific operating manner for “save” and “share” can be the same manner as that described above.

As shown in FIG. 9, in one embodiment, the in response to a request for the specific period from a user, executing an operation corresponding to the request on the multimedia resources corresponding to the specific period in step S103 can comprise the step (S1035) of merging multimedia resources remaining after the specific period is deleted to obtain merged multimedia resource segments in response to a request for deleting and merging the specific period from the user.

For example, as shown in Table 1, as for “statistically analyzing a time distribution for each type of emoji entered by the user with respect to the multimedia resources respectively; and respectively determining, based on the time distribution, a period during which occurrence density of each type of emoji is greatest as a specific period corresponding to each type of emoji,” it can be determined that the period during which occurrence density of the grinning face icon is greatest is 00:50:00-00:51:00, and the period during which occurrence density of the weeping face icon is greatest is 00:60:00-00:61:00. The above two periods can be associated with a “delete and merge” button in the multimedia resource playing interface. When a user clicks the button, a corresponding request can be generated. In response to the request, the server can generate a selection interface for the user to select periods required to be deleted. The server deletes multimedia resources of corresponding periods and merges remaining multimedia resources to obtain merged multimedia resource segments according to the selection of the user. For example, if the user does not like watching overly sad plots and wants to select to delete a period 00:60:00-00:61:00 during which occurrence density of the weeping face icon is greatest, then the user can select to delete multimedia resources corresponding to the period. In response to the request from the user, the server deletes multimedia resources corresponding to the period 00:60:00-00:61:00, and merges remaining multimedia resources to obtain merged multimedia resource segments for viewing, sharing, saving and the like by the user.

With the method for processing multimedia resources according to the embodiment, the user is enabled to delete disliked/inappropriate multimedia resource segments and merge remaining multimedia resource segments for viewing, sharing, saving and the like.

It should be noted that those skilled in the art could determine that deletion of a plurality of multimedia resource segments can be achieved by using the existing relevant multimedia processing (clipping) technology.

Step S103 can further comprise the step (S1036) of playing, saving, or sharing the multimedia resource segments in response to a request for playback, saving, or sharing the multimedia resource segments from the user.

For example, the above multimedia resource segments obtained by means of deletion followed by merging can be associated with the “play” button, the “save” button, and the “share” button in the multimedia resource playing interface. When the user clicks a corresponding button, a corresponding request can be generated. In response to the request, the server can play, save, or share the merged multimedia resource segments. Herein, the specific operating manner for “save” and “share” can be the same manner as that described above.

In one embodiment, an “extract hotspots” control can also be provided in the multimedia resource playing interface. When the user clicks the corresponding control, a corresponding request can be generated. In response to the request, the server can provide to the user an interface for selecting an extraction manner, such as “high-energy collection,” “emotion classification collection,” “emotion recommendation” and the like. The server can execute a corresponding multimedia resource processing process (method) according to the selection of the user, and present a processing result to the user for subsequently operating (playing, sharing, merging, deleting and the like) by the user. By means of the above configuration, users can extract relevant video segments according to their own needs, which improves user experience.

In one embodiment, after the specific period of the multimedia resources is determined, multimedia resources corresponding to the specific period can also be merged. For example, the server or the client automatically merges the multimedia resources corresponding to the specific period for subsequently operating by the user.

The methods for processing multimedia resources according to the disclosure are illustrated below using a plurality of examples.

### Example 1

In one example, emojis such as icons representing happiness or surprise and the like entered by a current user or all users in multimedia can be obtained. The emojis can be bullet screen icons entered in real time. All emojis occurring in the multimedia are analyzed to obtain a time distribution of the occurrence of the emojis. One or a plurality of time slices during which icon occurrence density is greatest are selected based on density of the time distribution and are used as the specific period. Multimedia resource segments corresponding to the above specific period can be directly displayed or merged and then displayed, or can be associated with a control (e.g., “click to display high-energy segments”) in the multimedia resource playing interface for display or merged display in response to a request generated when the user clicks the control. For example, occurrence density of all icons is greatest in the 50th to 51th minute. After the user selects “click to display high-energy segments,” the server directly skips to the video of the 50th to 51th minute for display. A ‘high-energy collection’ of multimedia resources of a specific period can also be directly generated and recommended to the user for playback and viewing by the user, for saving and sharing to friends by the user, and the like.

### Example 2

In one example, emojis such as icons representing happiness or surprise and the like entered by a current user or all users in multimedia can be obtained. The emojis can be bullet screen icons entered in real time. All the emojis occurring in the multimedia are analyzed, so a time distribution of the occurrence of each type of emoji can be respectively obtained. One or a plurality of time slices during which occurrence density for each type of emoji is greatest can be selected based on density of the time distribution and are used as the specific period. The specific period corresponding to each type of emoji is respectively associated with an emotion control (e.g., “click to display happy segments,” “click to display sad segments” and the like) corresponding to an emoji. In response to a request generated when the user clicks the control, one or a plurality of specific periods corresponding to the control can be displayed or merged and then displayed. For example, occurrence density of the grinning face icon is relatively great in the 0th to 1rst minute and the 50th to 51th minute. After the user selects “click to display happy segments,” segments of the 0th to 1rst minute and the 50th to 51th minute are directly displayed. A ‘high-energy collection’ corresponding to each type of emoji can also be directly generated and recommended to the user for playback and viewing by the user, for saving and sharing to friends by the user, and the like.

### Example 3

In one example, emojis such as icons representing happiness or surprise and the like entered by a current user or all users in multimedia can be obtained. The emojis can be bullet screen icons entered in real time. Each type of emoji occurring in multimedia is analyzed, so a time distribution of each type of emoji and the ranking of the total number of each type of emojis can be obtained. One or a plurality of emojis with the top-ranked total numbers are used as recommended types. For example, the first-ranked emoji is used as a recommended type. If equally-ranked emojis exist, either or both can be selected as the recommended types, which is not limited in the disclosure. One or a plurality of time slices during which occurrence density of the emoji is greatest in the recommended type can be selected based on the density of the time distribution and are used as the specific period. A ‘high-energy collection’ can be directly generated and recommended to the user for viewing by the user, for saving and sharing to friends by the user, and the like. Alternatively, it can be associated with a control (e.g., “click to display high-energy segments”) in the multimedia resource playing interface for display or merged display in response to a request generated when the user clicks the control. For example, if the number of smiley face icons in a video is 1000 and the number of surprise icons is 800, then three high-energy segments of the smiley face type are merged and then recommended to the user. Taking Table 1 as an example, an icon having the greatest number of occurrences among all emoji types is the grinning face icon, which occurred 169 times. The grinning face icon can be used as a recommended type; and the period 00:50:00-00:51:00 during which occurrence density of the grinning face icon is greatest is used as the specific period. After the user selects “click to display high-energy segments,” segments of the 50th to 51rst minute can be directly displayed.

### Example 4

In one example, emojis such as icons representing happiness or surprise and the like entered by a current user or all users in multimedia can be obtained. The emojis can be bullet screen icons entered in real time. All the emojis occurring in the multimedia are analyzed, so a time distribution of the occurrence of the emojis can be obtained. One or a plurality of time slices during which occurrence density of each type of emoji is greatest can be selected based on density of the time distribution and are used as the specific period. The above one or plurality of time slices can be highlighted in a specific manner for selection or deletion by the user. Taking a video as an example, the highlighting can be executed by highlighting, bold-displaying, or adding a mark to a progress bar portion corresponding to a specific period. Highlighting the specific period can help the user to directly select and click the corresponding progress bar portion to execute operations such as playing, sharing, saving, or deletion. Multimedia segments corresponding to time slices that are selected to be merged or merged after deletion by the user can be displayed, or a ‘high-energy collection’ can be generated for the multimedia segments for viewing by the user, or for the user to save and share with friends and the like.

### Example 5

In one example, emojis such as icons representing happiness or surprise and the like entered by a current user or all users in multimedia can be obtained. The emojis can be bullet screen icons entered in real time. All the emojis occurring in the multimedia are analyzed, so a time distribution of the occurrence of each type of emoji can be respectively obtained. One or a plurality of time slices during which occurrence density of each type of emoji is greatest can be selected based on density of the time distribution and are used as the specific period. When the user clicks a certain emoji classification, the above one or plurality of time slices can be highlighted in a specific manner for playback, selection, or deletion by the user. The highlighting manner can be the same manner as that in example 4. The multimedia segments corresponding to the time slices that are selected to be merged or merged after deletion by the user can be displayed, or a ‘high-energy collection’ can be generated for the multimedia segments for viewing and/or sharing to friends by the user.

### Example 6

In one example, an “extract hotspots” control can be generated in the multimedia resource playing interface. In response to a triggering request from the user, emojis such as icons representing happiness or surprise and the like entered by a current user or all users in multimedia are obtained. The emojis can be bullet screen icons entered in real time. All the emojis occurring in the multimedia can be analyzed according to the triggering request, to determine a corresponding specific period. For example, the specific period can be determined in accordance with the manner as shown in the above examples 1-5. In response to a request for the specific period from the user, an operation corresponding to the request can be executed on the multimedia resources corresponding to the specific period. Similarly, the multimedia resources can also be processed in response to a user request in accordance with the above examples 1-5, which is not repeatedly described.

It is noted that the above examples 1-6 are merely used as a further explanation of the method for processing multimedia resources according to the disclosure, and those skilled in the art could understand that the disclosure is not limited thereto.

In this way, through segmenting and processing multimedia resources according to an emoji entered by a user, the method for processing multimedia resources according to the above embodiment of the disclosure can be used so a user can view segments and execute and operation in a targeted manner. Since an emoji can well reflect emotions of the user during the viewing process, the specific period obtained by means of the method for processing multimedia resources according to various aspects of the disclosure reflects an emotion tendency of the user, and multimedia resources can be effectively segmented based on the user's emotion, thereby improving the viewing experience of the user.

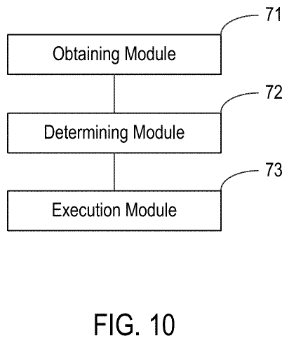

FIG. 10 is a block diagram illustrating an apparatus for processing multimedia resources according to some embodiments of disclosure. The apparatus can be used in servers or terminal devices such as smartphones and computers. As shown in FIG. 10, the apparatus can comprise: an obtaining module 71, a determining module 72, and an execution module 73.

The obtaining module 71 is used for obtaining a time distribution of an icon entered by a user with respect to multimedia resources.

The determining module 72 is used for determining a specific period of the multimedia resources based on the time distribution.

The execution module 73 is used for, in response to a request for the specific period from a user, executing an operation corresponding to the request on the multimedia resources corresponding to the specific period.

Through determining a specific period of multimedia resources based on a time distribution of an icon entered by a user with respect to the multimedia resources and through executing an operation on the multimedia resources of the specific period, the apparatus for processing multimedia resources according to various aspects of the disclosure can effectively execute segment division on multimedia resources for a user to view segments and execute operations in a targeted manner. Since the icon can well reflect the viewing reaction of the user, the specific period obtained by means of the apparatus for processing multimedia resources according to various aspects of the disclosure can be used to effectively segment multimedia resources based on a user reaction, facilitating rapid obtaining of a segment of interest by the user and improving the viewing experience of the user.

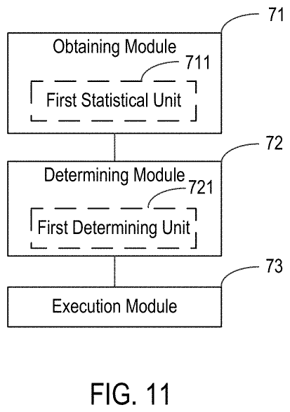

FIG. 11 is a block diagram illustrating an apparatus for processing multimedia resources according to some embodiments of disclosure. As shown in FIG. 11, the obtaining module 71 can comprise a first statistical unit 711 and the determining module 72 can comprise a first determining unit 721.

The first statistical unit 711 is used for statistically analyzing time distributions of all icons entered by the user with respect to the multimedia resources.

The first determining unit 721 is used for determining, based on the time distribution, a period during which icon occurrence density is greatest as the specific period.

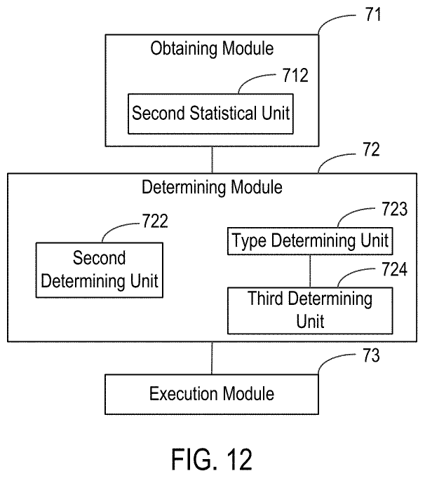

FIG. 12 is a block diagram illustrating an apparatus for processing multimedia resources according to some embodiments of disclosure. As shown in FIG. 12, the obtaining module 71 can comprise a second statistical unit 712 and the determining module can comprise a second determining unit 722, a type determining unit 723, and a third determining unit 724.

The second statistical unit 712 is used for statistically analyzing a time distribution for each type of icon entered by the user with respect to the multimedia resources respectively.

The second determining unit 722 is used for respectively determining, based on the time distribution, a period during which occurrence density is greatest for each type of icon as a specific period corresponding to each type of icon.

The type determining unit 723 is used for using a type of icon having the greatest number of occurrences among all icon types as a recommended type.

The third determining unit 724 is used for determining, based on the time distribution, a period during which occurrence density of the recommended type of icon is greatest as the specific period.

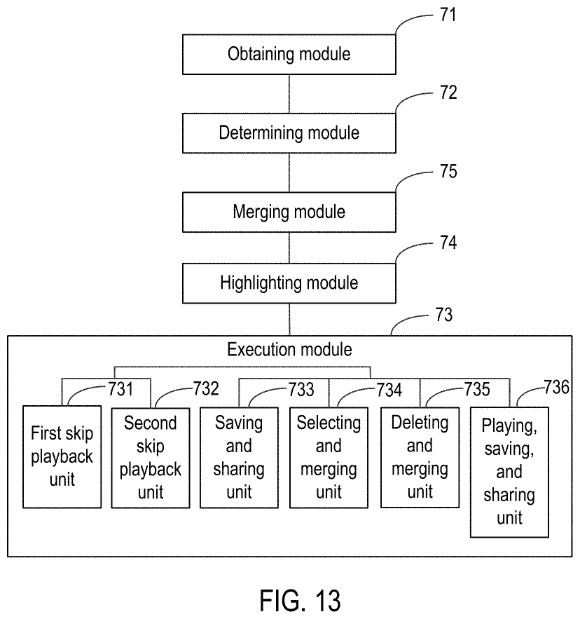

FIG. 13 is a block diagram illustrating an apparatus for processing multimedia resources according to some embodiments of disclosure. As shown in FIG. 13, the execution module 73 can comprise: one or a plurality of a first skip playback unit 731 and a second skip playback unit 732, and/or one or a plurality of a saving and sharing unit 733, a selecting and merging unit 734, a deleting and merging unit 735, and a playing, saving, and sharing unit 736.

The first skip playback unit 731 is used for, in response to a request for selecting playback of the specific period from the user, skipping to and playing the multimedia resources corresponding to the specific period.

The second skip playback unit 732 is used for, in response to a request for selecting playback of a specific period corresponding to a first type of icon from the user, skipping to and playing multimedia resources corresponding to the specific period corresponding to the first type of icon.

The saving and sharing unit 733 is used for, in response to a request for saving or sharing the specific period from the user, saving or sharing the multimedia resources corresponding to the specific period.

The selecting and merging unit 734 is used for, in response to a request for selecting and merging the specific period from the user, merging the multimedia resources corresponding to the selected specific period to obtain merged multimedia resource segments.

The deleting and merging unit 735 is used for, in response to a request for deleting and merging the specific period from the user, merging multimedia resources remaining after the specific period is deleted to obtain merged multimedia resource segments.

The playing, saving, and sharing unit 736 is used for, in response to a request for playback, saving, or sharing the multimedia resource segments from the user, playing, saving, or sharing the multimedia resource segments.

In one embodiment, the request is generated by clicking a skip playback control associated with the specific period.

In one embodiment, the apparatus can further comprise: a highlighting module 74. The highlighting module 74 is used for highlighting the specific period.

In one embodiment, the apparatus can further comprise: a merging module 75.

The merging module 75 is used for merging multimedia resources corresponding to the specific period.

In one embodiment, the icon comprises an icon in a bullet screen entered by the user with respect to the multimedia resources.

In one possible embodiment, the icon is an emoji.

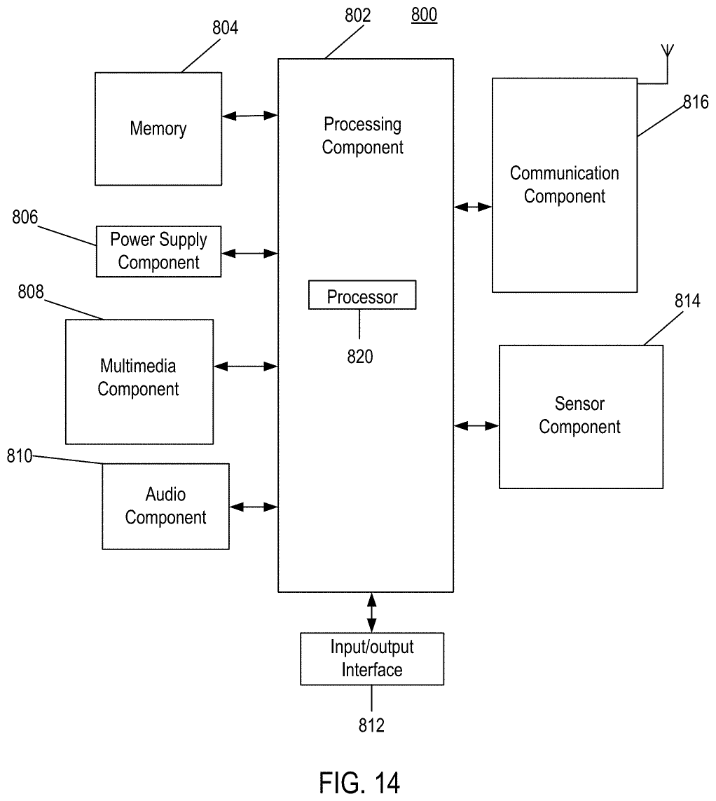

FIG. 14 is a block diagram illustrating an apparatus for processing multimedia resources according to some embodiments of disclosure. For example, the apparatus 800 can be a mobile phone, a computer, a digital broadcast terminal, a messaging device, a game console, a tablet device, a medical device, exercise equipment, a personal digital assistant, and the like.

With reference to FIG. 14, the apparatus 800 can comprise one or a plurality of the following components: a processing component 802, a memory 804, a power supply component 806, a multimedia component 808, an audio component 810, an input/output (I/O) interface 812, a sensor component 814, and a communication component 816.

The processing component 802 typically controls overall operations of the apparatus 800, such as operations associated with display, phone call, data communication, camera operation, and record operation. The processing component 802 can comprise one or a plurality of processors 820 to execute instructions to complete all or part of the steps of the method described above. In addition, the processing component 802 can comprise one or a plurality of modules to facilitate communication between the processing component 802 and other components. For example, the processing component 802 can comprise a multimedia module to facilitate interaction between the multimedia component 808 and the processing component 802.

The memory 804 is configured to store various types of data to support operations on the apparatus 800. Examples of the data include instructions for any application or method operating on the apparatus 800, contact data, phonebook data, messages, pictures, video and the like. The memory 804 can be implemented by any type of volatile or non-volatile storage device or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or an optical disk.

The power supply component 806 provides power to various components of the apparatus 800. The power supply component 806 can comprise a power management system, one or a plurality of power sources, and other components associated with generation, management, and distribution of power for the apparatus 800.

The multimedia component 808 comprises a screen that provides an output interface between the apparatus 800 and the user. In some embodiments, the screen can comprise a liquid crystal display (LCD) and a touch panel (TP). If the screen comprises a touch panel, the screen can be implemented as a touch screen to receive input signals from a user. The touch panel includes one or a plurality of touch sensors to sense touches, swipes, and gestures on the touch panel. The touch sensors may not only sense a boundary of a touch or swipe action, but also detect a period and a pressure related to the touch or swipe operation. In some embodiments, the multimedia component 808 comprises a front camera and/or a rear camera. When the apparatus 800 is in an operating mode, such as a shooting mode or a video mode, the front camera and/or the rear camera can receive external multimedia data. Each front camera and rear camera can be a fixed optical lens system or has focal length and optical zoom capability.

The audio component 810 is configured to output and/or input audio signals. For example, the audio component 810 comprises a microphone (MIC) configured to receive an external audio signal when the apparatus 800 is in an operating mode, such as a calling mode, a recording mode, and a voice recognition mode. The received audio signals can be further stored in the memory 804 or sent via the communication component 816. In some embodiments, the audio component 810 further comprises a speaker for outputting audio signals.

The I/O interface 812 provides an interface between the processing component 802 and a peripheral interface module. The above peripheral interface module can be a keyboard, a click wheel, a button, and the like. These buttons can include but not limited to: a home button, a volume button, a launch button, and a lock button.

The sensor component 814 comprises one or a plurality of sensors for providing state assessments of various aspects to the apparatus 800. For example, the sensor component 814 can detect an on/off state of the apparatus 800, relative positioning of components, for example, the components are a display and a keypad of the apparatus 800. The sensor component 814 can also detect a change in position of the apparatus 800 or one component of the apparatus 800, the presence or absence of user contact with the apparatus 800, the orientation or acceleration/deceleration of the apparatus 800, and a change in temperature of the apparatus 800. The sensor component 814 can comprise a proximity sensor configured to detect the presence of a nearby object when there is no physical contact. The sensor component 814 can further comprise an optical sensor, such as a CMOS or CCD image sensor for use in imaging applications. In some embodiments, the sensor component 814 can further comprise an acceleration sensor, a gyroscope sensor, a magnetic sensor, a pressure sensor, or a temperature sensor.

The communication component 816 is configured to facilitate wired or wireless communication between the apparatus 800 and other devices. The apparatus 800 can access a wireless network based on a communication standard, such as Wi-Fi (Wireless Fidelity), 2G or 3G, or a combination thereof. In one exemplary embodiment, the communication component 816 receives broadcast signals or broadcast-related information from an external broadcast management system via a broadcast channel. In one exemplary embodiment, the communication component 816 further comprises a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technology.

In an exemplary embodiment, the apparatus 800 can be implemented by one or a plurality of application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above method.

In an exemplary embodiment, a non-volatile computer-readable storage medium including instructions is further provided; for example, the memory 804 including instructions that can be executed by the processor 820 of the apparatus 800 to complete the method described above.

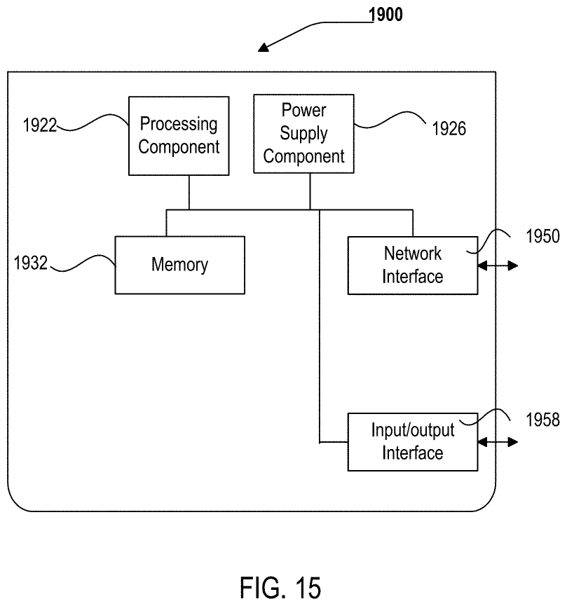

FIG. 15 is a block diagram illustrating an apparatus for processing multimedia resources according to some embodiments of the disclosure.

For example, the apparatus 1900 can be provided as a server. With reference to FIG. 15, the apparatus 1900 comprises a processing component 1922 that further comprises one or a plurality of processors, and a memory resource represented by a memory 1932 for storing instructions that can be executed by the processing component 1922, such as an application. The application stored in the memory 1932 can comprise one or a plurality of modules each corresponding to a set of instructions. In addition, the processing component 1922 is configured to execute instructions to execute the method described above.

The apparatus 1900 can further comprise a power supply component 1926 configured to execute power management of the apparatus 1900, a wired or wireless network interface 1950 configured to connect the apparatus 1900 to a network, and an input/output (I/O) interface 1958. The apparatus 1900 can operate based on an operating system stored in the memory 1932, for example, Windows Server®, Mac OS X®, Unix®, Linux®, FreeBSD® and the like.

In an exemplary embodiment, a non-volatile computer-readable storage medium including instructions is further provided; for example, the memory 1932 including instructions that can be executed by the processor 1922 of the apparatus 1900 to complete the method described above.

The disclosure can be an apparatus, a method, and/or a computer program product. The computer program product may comprise a computer-readable storage medium having computer-readable program instructions carried thereon for causing a processor to implement various aspects of the disclosure.

The computer-readable storage medium can be a tangible device that can hold and store instructions used by instruction execution device. The computer-readable storage medium may be, for example, but is not limited to an electrical storage device, a magnetic storage device, an optical storage device, an electromagnetic storage device, a semiconductor memory device, or any suitable combination thereof. More specific examples of the computer readable storage medium (a non-exhaustive list) include: a portable computer disk, a hard disk, a random access memory (RAM), a read only memory (ROM), a erasable programmable read only memory (EPROM or flash memory), a static random access memory (SRAM), a portable compact disc read-only memory (CD ROM), a digital versatile disk (DVD), a memory stick, a floppy disk, a mechanical coding equipment, such as a punch card with instructions stored thereon or a structure of bumps within recessions, and any suitable combination thereof. The computer-readable storage medium used herein is not interpreted as transient signals themselves, such as radio waves or other freely propagated electromagnetic waves, electromagnetic waves propagated through a waveguide or other transmission media (e.g., light pulses passing through a fiber optic cable), or electrical signals transmitted through electric wires.

The computer readable program instructions described herein may be downloaded from a computer-readable storage medium to various computing/processing devices or downloaded to an external computer or external storage device via a network such as the Internet, a local area network, a wide area network and/or a wireless network. The network may include copper transmission cables, fiber transmission, wireless transmission, routers, firewalls, switches, gateway computers, and/or edge servers. A network adapter card or a network interface in each computing/processing device receives computer-readable program instructions from the network and forwards the computer readable program instructions, for storing them in a computer readable storage medium in each computing/processing device.

Computer program instructions for executing the operations of the disclosure can be assembly instructions, instruction set architecture (ISA) instructions, machine instructions, machine related instructions, microcode, firmware instructions, state setting data, or source code or object code written in any combination of one or a plurality of programming languages, the programming language including object oriented programming languages such as Smalltalk, C++ and the like, and conventional procedural programming languages such as “C” language or similar programming languages. The computer-readable program instructions can be executed entirely or partly on a user computer, executed as a stand-alone software package, executed partly on a user computer and partly on a remote computer, or executed entirely on a remote computer or server. In the case of a remote computer, the remote computer may be connected to the user's computer through any kind of network, including a local area network (LAN) or a wide area network (WAN). Alternatively, it can be connected to an external computer (for example, using an Internet service provider to connect via the Internet). In some embodiments, electronic circuits, such as programmable logic circuits, field programmable gate arrays (FPGAs), or programmable logic arrays (PLAs), are customized by utilizing state information of computer readable program instructions. The electronic circuits can execute computer readable program instructions to implement various aspects of the disclosure.

Aspects of the disclosure are described herein with reference to the flowcharts and/or block diagrams of the methods, apparatuses (systems), and computer program products according to the embodiments of the disclosure. Each block of the flowcharts and/or block diagrams and combinations of various blocks in the flowcharts and/or block diagrams can be implemented by computer readable program instructions.

These computer program instructions may be provided to a processor of a general-purpose computer, a special-purpose computer, or other programmable data processing apparatuses, to produce a machine, so that these instructions, when executed by the processor of the computer or other programmable data processing apparatuses, produce an apparatus for implementing the functions/actions specified in one or a plurality of the blocks of the flowcharts and/or block diagrams. Also, these computer readable program instructions may be stored in a computer readable storage medium. These instructions cause a computer, a programmable data processing device, and/or other devices to work in a specific manner; thus, the computer readable medium storing the instructions includes an artifact, including instructions that implement various aspects of the functions/actions specified in one or a plurality of the flowcharts and/or block diagrams.

The computer program instructions may also be loaded onto a computer, other programmable data processing apparatuses, or other devices, such that the computer, other programmable data processing apparatuses or other devices execute a series of operational steps, to generate a computer-implemented process, such that the functions/actions specified in one or a plurality of the flowcharts and/or block diagrams are implemented by the instructions executed on the computer, other programmable data processing apparatuses, or other devices.

The flowcharts and block diagrams in the accompanying drawings illustrate system architectures, functions, and operations of embodiments of the system, method, and computer program product according to a plurality of embodiments of the disclosure. In this regard, each block in the flowcharts or block diagrams may represent a portion of a module, program segment, or instruction that contains one or a plurality of executable instructions for implementing the specified logical functions. In some alternative implementations, the functions denoted in the blocks can also occur in a different order than that illustrated in the drawings. For example, two consecutive blocks can be executed substantially in parallel, sometimes can also be executed in a reverse order, depending upon the functions involved. It is also noted that each block of the block diagrams and/or flowcharts, and combinations of blocks in the block diagrams and/or flowcharts can be implemented in a dedicated hardware-based system that executes the specified function or action, or can be implemented by a combination of dedicated hardware and computer instructions.

The embodiments of the disclosure have been described above. The foregoing description is illustrative rather than limiting, and is not limited to the disclosed embodiments. Many modifications and variations are apparent to those ordinarily skilled in the art without departing from the scope and spirit of the embodiments illustrated. The selection of terms used herein is intended to best explain the principles, practical applications, or technical improvements to the techniques in the market of the embodiments, or to enable other ordinarily skilled in the art to understand the embodiments disclosed herein.

1-31. (canceled)

32. A method comprising:
obtaining a time distribution of an icon entered by a user with respect to multimedia resources;
determining a specific period of the multimedia resources based on the time distribution; and
in response to a request for the specific period from a user, executing an operation based on the request on the multimedia resources based on the specific period.

33. The method of claim 32, the obtaining a time distribution comprising statistically analyzing time distributions of all icons entered by the user with respect to the multimedia resources, and the determining a specific period of the multimedia resources comprising setting, based on the time distribution, a period during which an icon occurrence density is greatest as the specific period.

34. The method of claim 32, the obtaining a time distribution comprising statistically analyzing a time distribution for each type of icon entered by the user with respect to the multimedia resources respectively, and the determining a specific period of the multimedia resources comprising setting, based on the time distribution, a period during which occurrence density is greatest for each type of icon as a specific period based on each type of icon.

35. The method of claim 34, the determining a specific period of the multimedia resources comprising:
using an icon type having a greatest number of occurrences among all icon types as a recommended type; and
setting, based on the time distribution, a period during which occurrence density of the recommended type of icon is greatest as the specific period.

36. The method of claim 32, the executing an operation comprising, in response to a request for selecting playback of the specific period from the user, skipping to and playing the multimedia resources based on the specific period.

37. The method of claim 32, the executing an operation comprising, in response to a request for selecting playback of a specific period based on a first type of icon from the user, skipping to and playing multimedia resources based on the specific period based on the first type of icon.

38. The method of claim 32, the executing an operation comprising, in response to a request for saving or sharing the specific period from the user, saving or sharing the multimedia resources based on the specific period.

39. The method of claim 32, further comprising highlighting the specific period.

40. The method of claim 32, the executing an operation comprising, in response to a request for selecting and merging the specific period from the user, performing one or more of:
merging the multimedia resources based on the selected specific period to obtain merged multimedia resource segments; or
merging multimedia resources remaining after the specific period is deleted to obtain merged multimedia resource segments.

41. The method of claim 40, the executing an operation comprising, in response to a request for playback, saving, or sharing the multimedia resource segments from the user, playing, saving, or sharing the multimedia resource segments.

42. A non-transitory computer readable storage medium for tangibly storing computer program instructions capable of being executed by a computer processor, the computer program instructions defining the steps of:
obtaining a time distribution of an icon entered by a user with respect to multimedia resources;
determining a specific period of the multimedia resources based on the time distribution; and
in response to a request for the specific period from a user, executing an operation based on the request on the multimedia resources based on the specific period.

43. The non-transitory computer readable storage medium of claim 42, the obtaining a time distribution comprising statistically analyzing time distributions of all icons entered by the user with respect to the multimedia resources, and the determining a specific period of the multimedia resources comprising setting, based on the time distribution, a period during which an icon occurrence density is greatest as the specific period.

44. The non-transitory computer readable storage medium of claim 42, the obtaining a time distribution comprising statistically analyzing a time distribution for each type of icon entered by the user with respect to the multimedia resources respectively, and the determining a specific period of the multimedia resources comprising setting, based on the time distribution, a period during which occurrence density is greatest for each type of icon as a specific period based on each type of icon.

45. The non-transitory computer readable storage medium of claim 44, the determining a specific period of the multimedia resources comprising:
using an icon type having a greatest number of occurrences among all icon types as a recommended type; and
setting, based on the time distribution, a period during which occurrence density of the recommended type of icon is greatest as the specific period.

46. The non-transitory computer readable storage medium of claim 42, the executing an operation comprising, in response to a request for selecting playback of the specific period from the user, skipping to and playing the multimedia resources based on the specific period.

47. The non-transitory computer readable storage medium of claim 42, the executing an operation comprising, in response to a request for selecting playback of a specific period based on a first type of icon from the user, skipping to and playing multimedia resources based on the specific period based on the first type of icon.

48. The non-transitory computer readable storage medium of claim 42, the executing an operation comprising, in response to a request for saving or sharing the specific period from the user, saving or sharing the multimedia resources based on the specific period.

49. The non-transitory computer readable storage medium of claim 42, the computer program instructions further defining the step of highlighting the specific period.

50. The non-transitory computer readable storage medium of claim 42, the executing an operation comprising, in response to a request for selecting and merging the specific period from the user, performing one or more of:
merging the multimedia resources based on the selected specific period to obtain merged multimedia resource segments; or
merging multimedia resources remaining after the specific period is deleted to obtain merged multimedia resource segments.

51. The non-transitory computer readable storage medium of claim 50, the executing an operation comprising, in response to a request for playback, saving, or sharing the multimedia resource segments from the user, playing, saving, or sharing the multimedia resource segments.
